(19) United States
(12) Patent Application Publication
(10) Pub. No.: US 2002/0073176 A1
(43) Pub. Date: Jun. 13, 2002

(54) User support apparatus and system using agents

(75) Inventors: Mutsumi Ikeda, Saitama (JP); Atsushi Maeda, Osaka (JP); Tsugufumi Matsuoka, Osaka (JP)

Correspondence Address: LYON & LYON LLP, 633 WEST FIFTH STREET, SUITE 4700, LOS ANGELES, CA, 90071, US

(73) Assignee: SANYO ELECTRIC CO., LTD.

(21) Appl. No.: 09/823,330

(22) Filed: Mar. 30, 2001

(30) Foreign Application Priority Data
Dec. 7, 2000 (JP) 2000-373601

(51) Int. Cl. G06F 15/16

(52) U.S. Cl. 709/219; 709/204

(57) ABSTRACT

A user support system using an agent technology is provided. An entrance server identifies a user utterance by matching it with a collection of anticipated user utterances. A specialized server to respond to the user utterance is determined according to the identified user utterance. The specialized server has a collection of action patterns of an agent for responding to the user utterance. The agent supports the user to search information or navigates the user to access desired information by friendly talking with the user. Information providers can sponsor the agent. When the agent displays information requested by the user, information related to the sponsors, particularly their advertisements, will be outstandingly displayed.

### BACKGROUND OF THE INVENTION

1. Field of the Invention

The present invention relates to a user support technique, and it particularly relates to a user support system that supports users' processes such as an operation and an information retrieval using agents.

2. Description of the Related Art

Since the Internet access at home has been common recently, WWW (World Wide Web) users are growing rapidly. It is very likely that necessary information that users want exists somewhere in the huge number of web sites. As it is convenient for the users at home to access to a huge amount of information from all over the world, the number of the users is further increasing.

As the population of the Web users grows, the WWW is also playing a role as advertising media. Many advertisers place their advertisements on their Web sites and the other popular Web sites. If the advertisements are placed on the other's Web sites, the advertisers can provide their advertisements with links to their own Web sites so that they can redirect the users to their Web sites easily. The conventional media such as TV, radio, and newspapers do not have such a feature.

However the population of both information providers and readers is explosively growing and such an unexpected growth is becoming a hindrance to utilizing available information very well. From the viewpoint of users, it is very difficult to find out desired information among a large amount of available information. Since many beginners or persons who lack computer literacy are accessing the Internet today, it is required to develop a technology by which such novices can search information easily.

On the other hand, from the viewpoint of information providers, advertising on the Web has not been effectively conducted. Since information infrastructure is not likely to catch up with the explosive growth of the user population, an image-based advertisement such as a banner ad puts a heavy network load and becomes certainly a time-consuming process when users are browsing the Web. Moreover, not many users are likely to click the banner advertisement to look at its details. Therefore a more effective advertising technology is necessary to appeal users.

### SUMMARY OF THE INVENTION

The present invention has been made with a view to the above-mentioned problems, and an object thereof is to provide a user support technology by means of which a user can get desired information in a friendly environment or desired processes can be efficiently executed on a computer or other devices. Another object of the present invention is to provide an efficient advertising technology.

According to one aspect of the present invention, a user support apparatus is provided. The apparatus comprises an utterance identification block which has an electronic collection of anticipated user utterances, and identifies a content of an inputted user utterance, a response block which has an electronic collection of action patterns for an agent for responding to the user utterances, and enables the agent to respond to the inputted user utterances, a search unit which searches information requested by the user among information offered by a plurality of information providers, and a process unit which executes a process for prioritizing the information providers. The utterance identification block further includes an additional collection of anticipated utterances that trigger the prioritizing process, and the process unit initiates the prioritizing process when the inputted user utterance is included in the additional utterance collection.

The agent here is a generic name of a function for supporting a user to search information or navigating the user to access desired information, and the function mainly enables a personified character to appear on a screen and converse with the user. The agent is not always a visible character but the agent here may also means a user support program that is itself invisible from the user or other functions such as a back-end process in the system. The action patterns of the agent include the agent utterances, images, behaviors, or any other processes related to supporting users. The utterance of the user and the agent is not only made in a voice, but also given in text data. The utterance may include oral or spoken words or sentences that can be converted to text data by speech recognition.

A specific information provider may be a sponsor who requests an administrator of the user support apparatus to provide an advertisement to the user and pays an advertising cost. The advertisement may be displayed during the conversation between the agent and the user. A plurality of sponsors may be registered to one agent so that the agent can present the advertisements of the sponsors to the user.

The additional utterance collection may be incorporated into the user utterance collection to form one united collection. Thereby when the user utterance is identified, both of the user utterance collection and the additional utterance collection can be referred to.

The process unit may arrange information related to a specific information provider at the top of a list of search results obtained by the search unit. Thereby even if multiple choices are obtained for the user's desired information, the choice related to the sponsor can outstand and the user can easily recognize the information offered by the sponsor.

The process unit may emphasize information related to a specific information provider when a search result obtained by the information search unit is presented to the user. For instance, the sponsor information may be highlighted with a different color, size, font type, or font style for ease of recognition. The sponsor information may be bordered with a frame or may be provided with a mark such as “recommendation”.

The user support apparatus may further comprise a setting unit which enables the user to register a specific information provider to be granted a high priority, and wherein the process unit executes the prioritizing process for the registered specific information provider. Since the user selects his/her favorite sponsors, the advertisements can be provided to appropriate target users.

According to another aspect of the present prevention, a user support system is provided. The system comprises a plurality of the user support apparatuses connected to a network as independent network nodes, each of the apparatuses corresponding to one specialized field. The user utterance collection, the agent action collection, and the additional utterance collection of each of the user support apparatuses are generated according to each specialized field. In this case, a server-client system is configured in which a terminal of the user is a client and each of the user support apparatuses is a server. The plural user support apparatuses may be each provided for each service category, such as news, fortune telling, travel, cooking, business, health and so on. In this case, since each of the user support apparatus has a specific theme, the agent on each user support apparatus can be easily maintained and refined. In addition, since the utterances on different topics are processed on the different network nodes, the system load can be distributed and balanced among the nodes.

In this system, the plural user support apparatuses may include the respective response blocks therein and share the utterance identification block at any one of the network nodes. In this configuration, the shared utterance identification block may include the user utterance collections of all other apparatuses. The user support apparatus including the utterance identification block may be an entrance server or a portal server that can identify all user utterances to be processed at the user support system. An appropriate user support apparatus for responding to the user utterance may be selected according to the content of the utterance identified by the server. Thereby the user utterance identification and the agent response can be processed at the different nodes resulting in a balanced or optimized load in the system.

In this system, the utterance identification block may include an utterance search unit which searches the utterance of the user in the user utterance collection, and a reporting unit which notifies a system administrator when the user utterance is not found in the user utterance collection. Thereby the administrator can revise the user utterance collection and the agent action collection.

The utterance identification block may further include an index storage that stores an index of contents of the user utterance collection. The search unit can initially perform an index-search for the inputted user utterance to narrow the search scope and the search speed can be improved.

The system may further include a library providing unit which offers the user utterance library to a third party off line or on line. For instance, the user utterance collection can be provided off line as a software package, and can be provided on line by offering an access right for a server that stores the user utterance collection. As the user utterance collection, a general utterance library that records natural user utterances as a natural language library may be provided to the third party. Thereby the third party can independently develop the user utterance collection, the additional utterance collection, and the agent action collection, and can create a new user support apparatus. As a result the user support system as a whole can be enhanced.

Moreover, any arbitrary combination of the abovementioned structural components in the present invention is still effective as an embodiment when applied as a method, a system, a server, a terminal or a computer program, and so forth.

This summary of the invention does not necessarily describe all necessary features, so that the invention may also be a sub-combination of these described features.

### BRIEF DESCRIPTION OF THE DRAWINGS

FIG. 1 is an overall structure of a network system including a user support system according to one embodiment.

FIG. 2 is an internal structure of an originating server in a user support system.

FIG. 3 is an internal structure of an index file in an originating server.

FIG. 4 is an internal structure of a user utterance collection in an originating server.

FIG. 5 is an internal structure of an access information file in an originating server.

FIG. 6 is an internal structure of a sponsor information file in an originating server.

FIG. 7 is an internal structure of an additional index file in an originating server.

FIG. 8 is an internal structure of an additional utterance collection in an originating server.

FIG. 9 is an internal structure of a gourmet server in a user support system.

FIG. 10 is an internal structure of a page containing a sponsor processing unit.

FIG. 11 is an internal structure of a user terminal to utilize a user support system.

FIG. 12 shows a local agent displayed on a screen when a user has activated a user terminal.

FIG. 13 shows a chat agent displayed on a screen when a user makes an utterance.

FIG. 14 shows a gourmet agent displayed on a screen when a user ask for specific information.

FIG. 15 shows how a gourmet agent presents a search result to a user.

FIG. 16 shows how a gourmet agent notifies a user of an updating status of a sponsor's site.

### DETAILED DESCRIPTION OF THE INVENTION

The invention will now be described on the basis of the preferred embodiments, which do not intend to limit the scope of the present invention, but exemplify the invention. All of the features and the combinations thereof described in the embodiment are not necessarily essential to the invention.

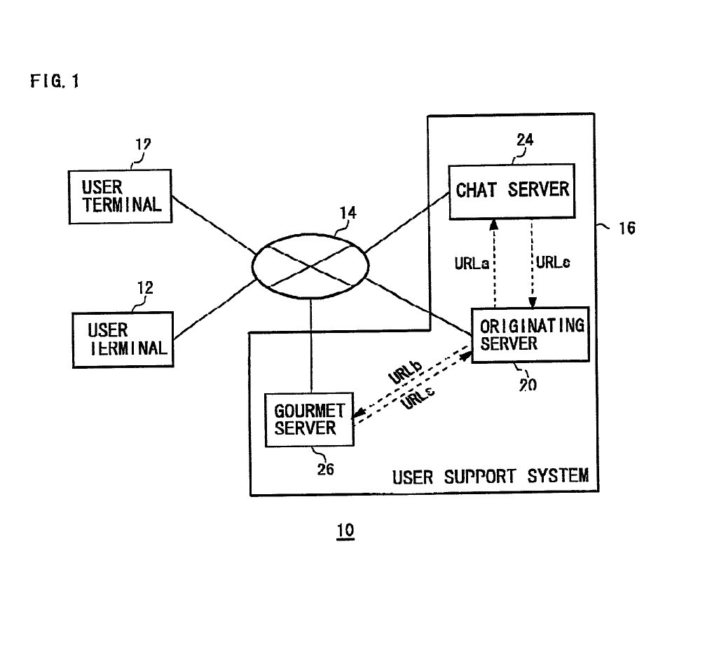

FIG. 1 shows an overall structure of a network system 10 including a user support system 16 according to one embodiment of the present invention. Here a user terminal 12 and a user support system 16 are connected to each other via the Internet 14. The user terminal 12 is a personal computer, a PDA or personal digital assistant, a mobile phone with access to the Internet 14, or any other suitable item of hardware.

The user support system 16 includes an originating server 20, a chat server 24 and a gourmet server 26. These three servers are connected to the Internet 14. The originating server 20 includes an electronic collection of users' anticipated utterances and an utterance identification block that identifies the content of an inputted user utterance. This utterance identification block is shared by other servers in the user support system, namely, the chat server 24 and the gourmet server 26. The chat server 24 and the gourmet server 26 each include an electronic collection of action patterns of an agent to respond to the utterance and have a response block that enables the agent to respond to the user utterance within each server node.

The originating server 20, the chat server 24, and the gourmet server 26 are configured as separate network nodes, and therefore the processes of user's utterance and agent's utterance can be distributed among the servers. Since an agent in charge of a different field can be also implemented in a different node, maintenance can be easily conducted for each of the agents. The names “chat server” and “gourmet server” are given according to a charged field or a specialized field of the agent. In the following, such servers as the chat server 24 and the gourmet server 26 are generally referred to as a specialized server, and agents placed on these servers are referred to as expert agents. Although the user support system 16 may be configured as one unit or apparatus, for instance as one component inside a portal site, it is assumed in the following that the system is configured as separate nodes and the originating server 20 serves as a portal server for the user terminal 12.

The user utterance is sent to the originating server 20 and its content is identified in the user utterance collection. Then an agent to respond to the utterance is identified according to the content and a response process is executed by the response block. An agent on the chat server 24, as also referred to as “a chat agent”, responds to general greetings such as “Hello”, and an agent on the gourmet server 26, as also referred to as “a gourmet agent”, responds to utterances related to cooking or dining such as “Tell me a restaurant serving good Peking ravioli”. Each expert agent finds out what kind of information the user wants during a talk with the user, and supports the user to search desired information among a large amount of available information.

In the user support system of this embodiment, an information provider, as also simply referred to as a sponsor, who makes a sponsor contract with an expert agent is granted a higher priority. For instance, consider that a car manufacturer is a sponsor for a chat agent and a user says, “I want to get information about a new-model car in this year”. Receiving this utterance, the chat agent searches some pages describing a new-model car among Web sites and presents them to the user. When the chat agent presents the search results, a page of Company A, which is a sponsor of the agent, is highlighted. For instance, a link to the page of Company A may be listed first, or the link may be highlighted with a different color, font or character size. The link to the page of Company A may be bordered with a frame or may be listed with a mark attached such as “recommendation” or “hot site”. The advertisement of Company A may be also displayed on the same screen. Thereby it is more likely for the user to access the sponsor's site and the effectiveness of advertising can be improved.

In this system, the sponsor Company A is charged for gaining such priority. The sponsor may be charged differently depending on the number of times when their site takes a high priority or the number of times when their advertisement is displayed. The sponsor may be charged only if the user visits to their site. Furthermore, the user may select a favorite sponsor. For instance, Company A, which is an instant food maker, Company B a car manufacturer, and Company C a restaurant are the sponsors for the chat agents. One user may set Company A as his/her favorite sponsor, while another user may set Company B as his/her favorite sponsor. If the user that sets Company A as his/her favorite sponsor says, “I want to eat noodles”, the advertisement of the company A is displayed according to the content of the utterance, but no advertisements of the company B and C are displayed. Thereby only information desired by users can be presented. The user who sets his/her favorite sponsor may be awarded some merit from the system administrator or the sponsor. For instance, the service fee may be reduced or cash or a gift may be awarded to the user.

The above-mentioned business model can be so-called Win-Win-Win model to produce profits to all of three parties, namely, a user, a sponsor and a system administrator. When the user browses Web pages, he/she can obtain desired information using an agent and be relieved of banner advertisements always occupying the screen. Since an appropriate advertisement is displayed only when a related utterance is made, it is not likely that unwanted advertisements are displayed. In addition, by setting a favorite sponsor, the user can be awarded and obtain hot information from the sponsor.

Since the sponsor can provide advertisements to the user who makes an utterance related to their products or services, they can expect high effectiveness of advertising. Since unwanted advertisements are not presented to users, the sponsor can save advertising costs and realize a high cost performance. By defining the utterances to trigger displaying the advertisements, a user target to provide the advertisements and advertising frequency can be adjusted. For instance, the system can be configured in such a manner that the advertisements of sponsors in Tokyo are displayed for the user who says, “Tell me a bar in Tokyo”, and the advertisements of sponsors in other areas are not displayed. The advertising frequency can be set to a high level by defining utterances that users may frequently use. On the other hand, the sponsor can target a specific user bracket by setting specialized terms for the advertisement.

The administrator of the user support system can take an advertisement fee from the sponsor. The system can provide users with advertisements more appropriately than banner advertisements and thereby can reduce network loads. Therefore the system can serve a lot of users and the administrator can gain a sufficient amount of the service fee from users and the advertisement fee from the sponsors.

Although full details are given below, the abstract of the process in FIG. 1 is as follows. When the user activates the user terminal 12, a local agent implemented inside the user terminal 12 appears on its screen. The local agent waits for the first utterance of the user. This utterance is referred to as a process starting utterance in the following. The process starting utterance is transmitted to the originating server 20 via the Internet 14. At that time, the user terminal 12 displays a Web page of the originating server 20 on a WWW browser.

The originating server 20 has a collection of user utterances, that is a collection of utterances that users are expected or anticipated to produce. An additional utterance collection is incorporated into the user utterance collection. The additional utterance collection is a collection of anticipated utterances that trigger a sponsor prioritizing process. The process starting utterance is matched with the collection and the content of the utterance is recognized. As a result, an expert agent appropriate to respond to the process starting utterance is identified and the URL of its specialized server, as denoted by URLa and URLb in the figure, is sent to the browser of the user terminal 12. When the user terminal 12 obtains the URL, a Web page of the specialized server is displayed on the screen, and the expert agent appears. The specialized server contains a collection of action patterns for the expert agent, and responds to the process starting utterance and subsequent user utterances, which are referred to as normal utterances. Although utterances of the agent are mainly considered as the agent behavior in the following, the agent may respond to the user through a gesture or other actions, or may respond by changing the color or texture of its image, or performing a search or any other program processes.

When the process starting utterance is included in an additional utterance collection of the sponsor specified by the user, the user's access destination moves to a page to perform a process for prioritizing sponsors, which is in a specialized server. The process of emphasizing the specified sponsor's Web page or displaying the sponsor's advertisement is executed on this page. Then the system waits until the user makes another utterance.

When the user makes a new utterance, that is a normal utterance, to the expert agent, the utterance is captured and sent to the originating server 20. The originating server 20 identifies again an expert agent to respond to the utterance, and then transmits the URL of its specialized server to the user terminal 12. Again, the following sequence is repeated:

1. the originating server 20 identifies a user utterance;

2. the originating server 20 identifies a specialized server appropriate to the identified utterance;

3. an expert agent on the specialized server responds to the user;

4. the sponsor prioritizing process is executed (only if the user utterance is contained in the additional utterance collection); and

5. the expert agent requests or prompts the user to make a normal utterance.

Thus, the process always returns to the originating server 20 and then restarts from there. It is for this reason that the server is named the originating server.

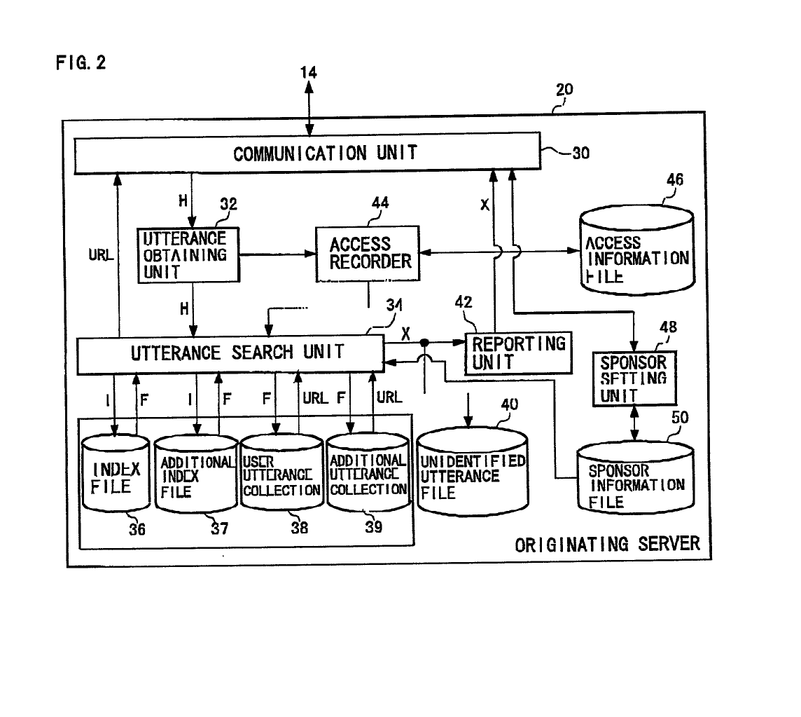

FIG. 2 shows an internal structure of the originating server 20. In this figure, “H” indicates utterance data, “I” an index search of the utterance, “F” a file name having the URL of a specialized server to respond to the utterance of the user, and “X” an unidentified utterance, respectively. The structure shown in FIG. 2 may be implemented with a CPU, memory and a program loaded in the memory. In the figure, however, the blocks are not divided in terms of hardware and/or software components, but in terms of function. The skilled in the art can therefore understand that the various combinations of hardware and software components can achieve the function of these blocks. The same consideration is applied to the whole specification.

A communication unit 30 communicates with the specialized server and the user terminal 12 via the Internet 14. An utterance obtaining unit 32 captures an utterance from a user and sends it to an utterance search unit 34. The utterance search unit 34 initially checks the first character of the utterance with an index file 36 to search by index, and then identifies the content of the utterance by conducting a phrase search through the whole utterance. The phrase search is a process of finding any phrase that matches the utterance not only by word but also by phrase. If no corresponding phrase is found, the utterance is divided into morphemes and a closely related expression is searched for by key word or word.

The index file 36 is generated by arranging the anticipated utterances stored in a user utterance collection 38 in the order of the Japanese syllabary. Since the first character of the utterance is checked with this index file 36, the search for the utterance can be conducted with great speed, even if the user utterance collection 38 is very large. As described below, since the user utterance collection can easily be enhanced in this embodiment, the utterance collection 38 can be greatly increased in size. In this respect, the speed gained by the initial index search is highly advantageous.

When an utterance is identified using the index file 36, a file descriptor of a file describing information such as a URL of a specialized server that should respond to the utterance is identified in the index file 36, and the file itself built into the user utterance collection 38 is opened and the proper URL obtained. The user utterance collection 38 has one file devoted to each utterance. The file contains a URL of a page to respond to the user utterance.

When the user utterance is also included in an additional utterance collection 39, a file in the additional utterance collection 39 corresponding to the utterance contains a URL of a page to execute a prioritizing process for granting a specific sponsor a high priority. A sponsor setting status stored in a sponsor information file 50 is now referred to. If the user has registered the specific sponsor as his/her favorite sponsor, the URL specified in the additional utterance collection 39 is used and the sponsor prioritizing process is executed. If the user has not registered the sponsor, the user access destination moves to the URL specified in the user utterance collection 38 and the sponsor prioritizing process is not executed.

The URL obtained in the user utterance collection 38 or the additional utterance collection 39 is forwarded to the browser of the user terminal 12 via the communication unit 30 and the user terminal 12 in turn accesses the specialized server. Strictly speaking, the URL does not point to a general Web page of the specialized server, but a personalized page to respond to the utterance of the user. One page is allocated to one utterance, and in some cases, multiple pages are allocated to one utterance. The latter cases are described below.

A statement exactly corresponding to the utterance of the user may not always have been previously stored in the user utterance collection 38. Especially in the process of enhancing the user utterance collection 38, a perfectly corresponding statement may not be found. In this case, the utterance search unit 34 breaks down the user utterance into morphemes by a known method and finds the most probable utterance from the user utterance collection 38 by re-searching employing a logical AND of nouns of morphemes or similar processes. Each utterance for which a re-search is conducted and each utterance for which the re-search is not-successful is recorded as an unidentified utterance in an unidentified utterance file 40, and an administrator of the originating server 20 is notified of this via the communication unit 42 in an electronic mail or the like. The administrator registers anew such unidentified utterances and the URL of a page of a specialized server that should respond to the utterance in the user utterance collection 38, and registers the indexes of the utterance in the index file 36, and then finally designs processes including utterances for the expert agent on that page. For this kind of maintenance, the unidentified utterance can be added straight to the user utterance collection 38 and no complicated process is involved. Therefore it is a very easy task to enhance the user utterance collection 38.

An additional index file 37 is generated by arranging the anticipated utterances stored in the additional utterance collection 39 in the order of the Japanese syllabary. In FIG. 2 the additional index file 37 and the index file 36 are depicted as separate files for ease of understating, but the contents of the additional index file 37 is actually incorporated into the index file 36.

The additional utterance collection 39 stores utterances that trigger the sponsor prioritizing process. In FIG. 2 the additional utterance collection 39 and the user utterance collection 38 are depicted separately for ease of understating, but the contents of the additional utterance collection 39 is actually incorporated into the user utterance collection 38. The utterances to be stored in the additional utterance collection 39 may be set by the sponsor. The sponsor can adjust the number of target users or a target user bracket by changing the contents of the additional utterance collection 39. A user database storing user attributes, which is not shown in the figure, may be provided and the advertisement may be displayed according to the user attributes.

An access record unit 44 records the status of each user's accessing of the specialized server in an access information file 46. This enables the expert agent to respond differently to identical user utterances. For instance, when a user who first visits the chat server 24 says “Hello”, the expert agent of the chat server 24, also referred to as a chat agent, will say “Nice to meet you”. On the other hand, if the user visits the chat server 24 again, the chat agent can say “Hello. How's it going?” and so on. Therefore, a certain sensitivity of response can be realized. The access record unit 44 notifies the utterance search unit 34 of the user's access status. If multiple pages of the specialized server are employed in the user utterance collection 38 in order to respond to a user utterance, as in this example, the utterance search unit 34 chooses an appropriate page under the user access status and sets the URL of the chosen page on the browser of the user terminal 12.

A sponsor setting unit 48 sets a sponsor specified by each user in a sponsor information file 50. The sponsor setting unit 48 presents the sponsors under contract with the specialized agent to the user and inquires of him/her which sponsor he/she would like to select. The sponsor selected by the user is stored in the sponsor information file 50.

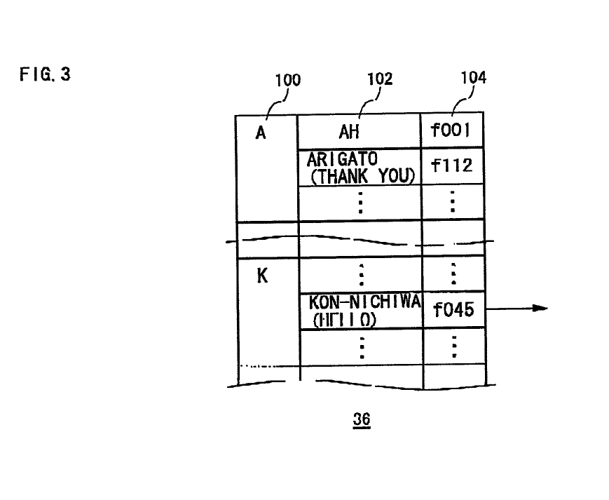

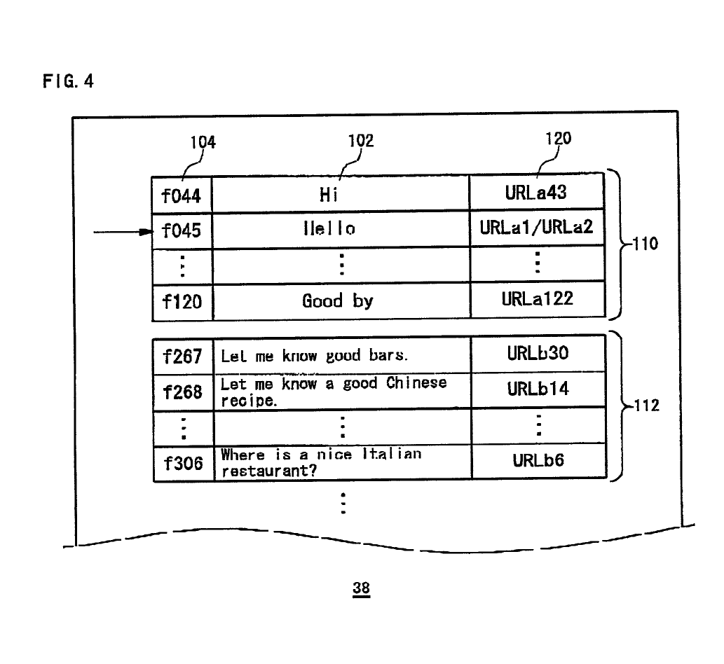

FIG. 3 is an internal structure of the index file 36. FIG. 4 is an internal structure of the user utterance collection 38. The index file 36 has a Japanese syllabary column 100, a user utterance column 102, and a file name column 104. The user utterances are arranged in the order of the Japanese syllabary. If the first character is “A”, the utterance is categorized corresponding to “A” of the Japanese syllabary column 100. Likewise, the utterances are categorized by using the first character as shown in the figure.

The user utterance collection 38 has a file name column 104, a user utterance column 102, and a page column 120 of a specialized server to respond to the user. For instance, a page of a specialized server to respond to the utterance “Hi” is URLa43, and a pair of the utterance “Hi” and URLa43 forms a file f044. The user utterances are gathered for each specialized server. For instance, the user utterances 110 which are linked to the chat server 24 are put together into one group, while the user utterances 120 linked to the gourmet server 26 are put together into another group. The index file 36 and the user utterance collection 38 are linked together via file names. For instance, the file name f045 is recorded corresponding to the utterance “Hello” in the index file 36, and the file name points to the file f045 in the user utterance collection 38.

As shown in FIG. 4, two pages, URLa1 and URLa2, correspond to “Hello”. URLa1 will be sent to a user who first visits the chat server 24 and URLa2 is sent to a user who visits the server a further time.

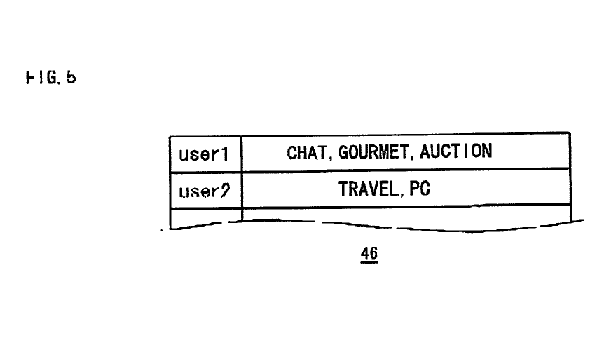

FIG. 5 illustrates an internal description of the access information file 46. In this figure, the user “user1” has visited the specialized servers called “chat”, “gourmet”, and “auction” before, while the user “user2” has already visited the specialized servers named “travel” and “PC”. Therefore, as stated above, when “user2” visits the chat server 24, the chat agent starts with an utterance prepared for first-time visitors. When “user1” visits the chat server 24, the chat agent produces an utterance prepared for revisitors.

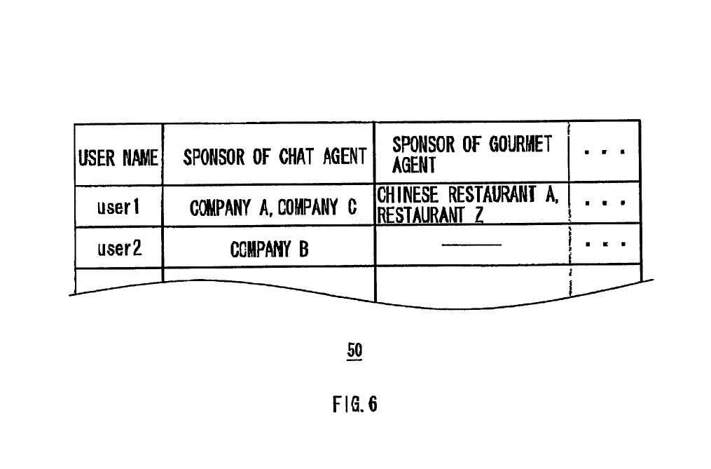

FIG. 6 is an internal structure of the sponsor information file 50. In this figure, one user “user1” sets “Company A” and “Company C” as sponsors of the chat agent and sets “Chinese Restaurant A” and “Restaurant Z” as sponsors of the gourmet agent. On the other hand, another user “user2” sets “Company B” as a sponsor of the chat agent. Therefore, while the user “user1” is talking with the chat agent, the advertisements of the companies A and C are displayed but the advertisements of the company B are not displayed.

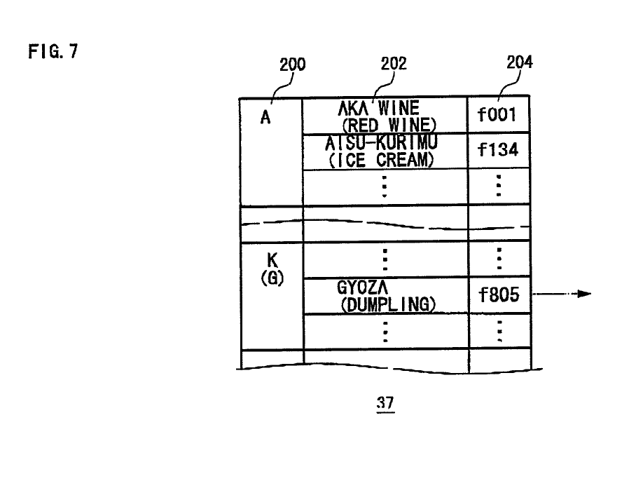

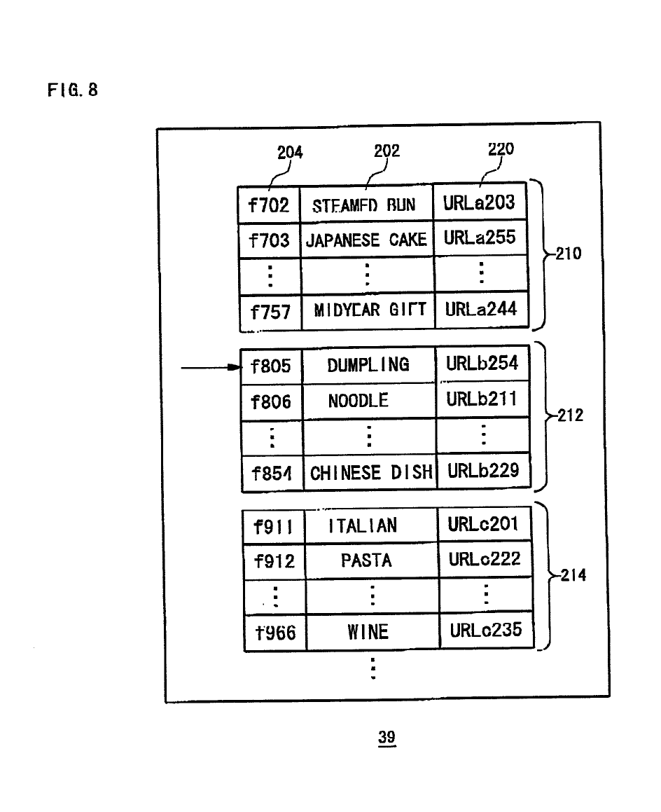

FIG. 7 is an internal structure of the additional index file 37. FIG. 8 is an internal structure of the additional utterance collection 39. As described above, the additional index file 37 and the additional utterance collection 39 are incorporated into the index file 36 and the user utterance collection 38 respectively, however, these files are explained here as separate files for ease of understanding. The additional index file 37 has a Japanese syllabary column 200, an agent utterance column 202, and a file name column 204. The user utterances are arranged in the order of the Japanese syllabary as in the index file 36.

The additional utterance collection 39 has a file name column 204, a user utterance column 202, and a page column 220 of a specialized server to respond. For instance, a page of a specialized server to respond to the agent utterance “steamed bun” is URLa203, and a pair of the utterance “steamed bun” and URLa203 forms a file f702. The user utterances are gathered for each specialized server as an utterance collection 210 for a Japanese case shop D, an utterance collection 212 for a Chinese restaurant A, and an utterance collection 214 for an Italian restaurant E. The additional index file 37 and the additional utterance collection 39 are linked together via file names. For instance, the file name f805 is recorded corresponding to the utterance “dumpling” in the additional index file 37, and the file name points to the file f805 in the additional utterance collection 39.

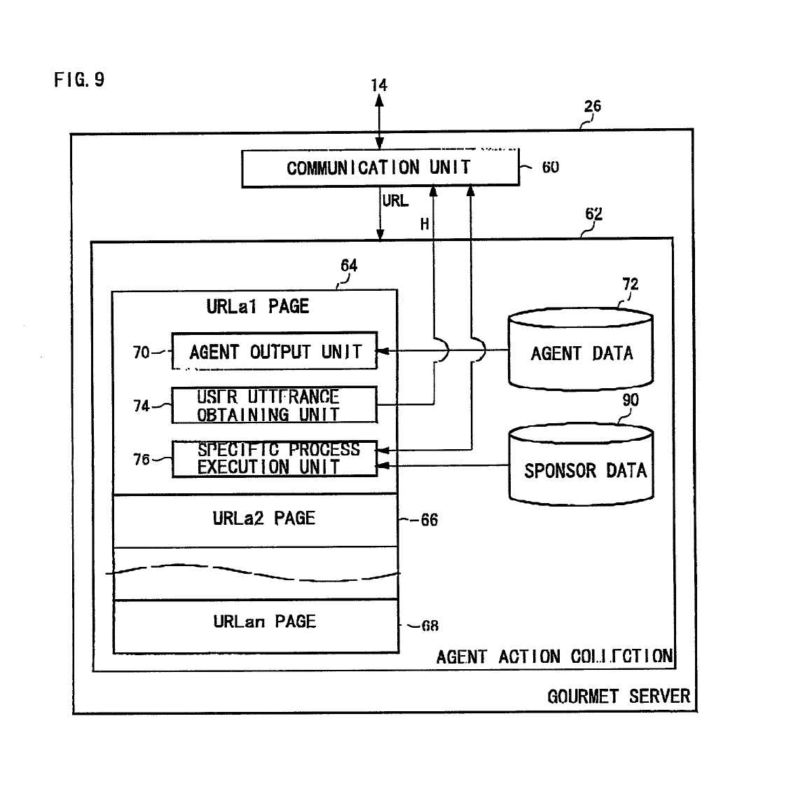

FIG. 9 is an internal structure of the gourmet server 26 as an example of a specialized server. A communication unit 60 communicates with the user terminal 12 and the originating server 20 via the Internet 14. The URL identified in the utterance search unit 34 of the originating server 20, for instance, URLa1 or URLa2 corresponding to the utterance “Hello” as in FIG. 4, is forwarded to an agent action collection 62 via the communication unit 60. The agent action collection 62 includes agent data 72 that describe images and action patterns of the expert agent as well as its utterances, and sponsor data 90 that stores advertisement data of the sponsors. One page corresponding to one URL identified by the utterance search unit 34 is also provided. For instance, a page 64 for URLa1, a page 66 for URLa2, and a page 68 for URLan are provided. The pages are Web pages that not only carry the utterances of the gourmet agent, but also display its image and behavior, and further perform services using the agent, for instance for information retrieval and such. Thus, by providing one Web page for each single utterance, fully flexible responses can be realized.

Each page has almost the same configuration, so only page 64 of URLa1 is described in detail in this figure. Page 64 of the URLa1 has an agent output unit 70, a user utterance obtaining unit 74, a specific process execution unit 76. These units can be configured in various manners such that the main functions remains at the server side like CGI or Common Gateway Interface, the main functions are transferred to the client side like a Java (trademark) applet or ActiveX (trademark), and an API or Application Program Interface type, that is, the main functions are provided at both the server and the client like a Java application. The agent output unit 70 responds to the user utterance through the gourmet agent on the basis of the agent data 72. The specific process execution unit 76 performs any processes other than that of responding to utterances, for instance, retrieving information and executing various types of programs. For example, if the user utterance that brought the user to access this page is “I want to know restaurants in Shijuku”, the gourmet agent will search information related to restaurants through the Internet 14 and present it to the user. The user utterance obtaining unit 74 thereafter obtains a normal utterance from the user, and notifies the originating server 20 of this. As a result, a new specialized server is identified by the originating server 20.

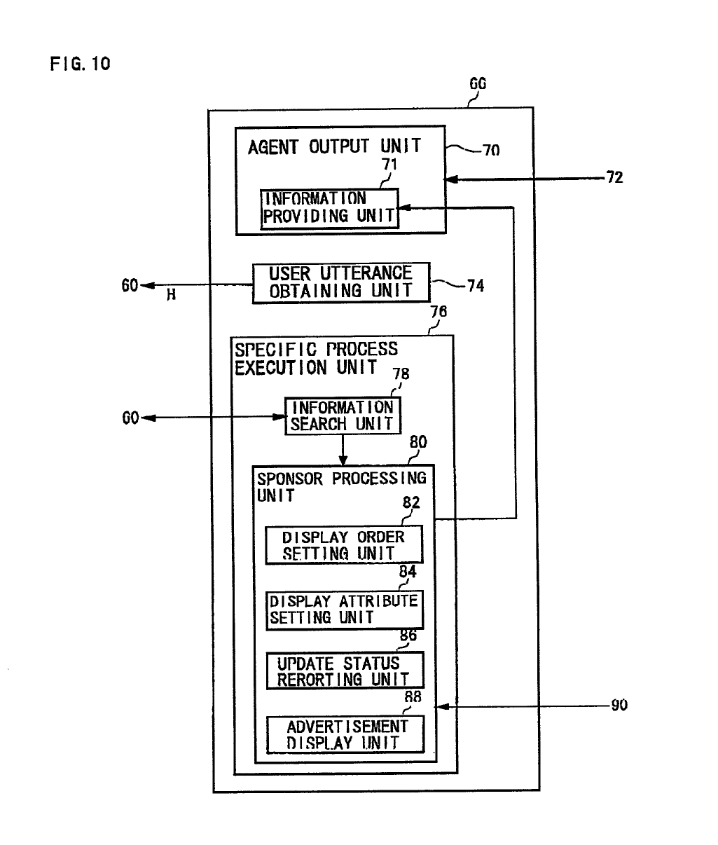

FIG. 10 is an internal structure of the page for executing the sponsor prioritizing process, which is stored in the agent action collection 62. The specific process executing unit 76 includes an information search unit 78 that searches information requested by the user through the Internet 14, and a sponsor processing unit 80 that executes the sponsor prioritizing process for the search results. The sponsor processing unit 80 includes a display order setting unit 82 that displays specific sponsor's information at the top of the listed search results, a display attribute setting unit 84 that emphasizes the displayed sponsor's information, an advertisement display unit 88 that displays the sponsor's advertisements, and a update status reporting unit 86 that notifies the user of the updating status of the sponsor's site. The sponsor processing unit 80 retrieves the information stored from the sponsor data 90 and determines how the sponsor's information should be displayed. The search results processed by the sponsor processing unit 80 are displayed to the user through an information providing unit 71 in the agent output unit 70.

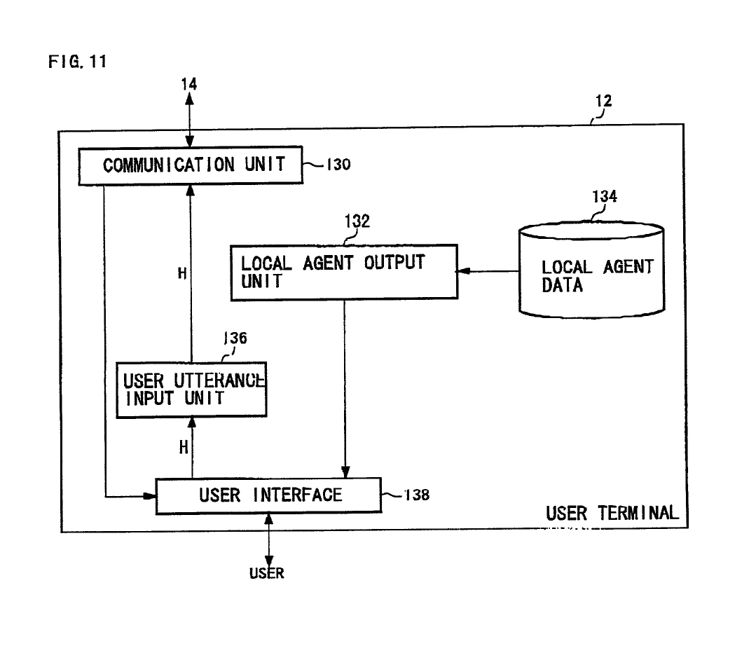

FIG. 11 shows the internal structure of the user terminal 12. A communication unit 130 communicates with the originating server 20, the chat server 24, the gourmet server 26, and other specialized servers via the Internet 14. A user interface 138 is a general term for the whole structure used to encourage a user to make a decision and enabling the user to input his/her decision, and it includes a keyboard, a mouse, a display, and other types of data interfaces. A local agent output unit 132 reads local agent data 134 and forwards the data to the user via a user interface 138. The process starting utterance and normal utterances of the user are forwarded to a user utterance input unit 136 and these data are sent to the originating server 20 via the communication unit 130 and the Internet 14. The processes involved in the above-mentioned configuration of the embodiment are now described using some examples as follows.

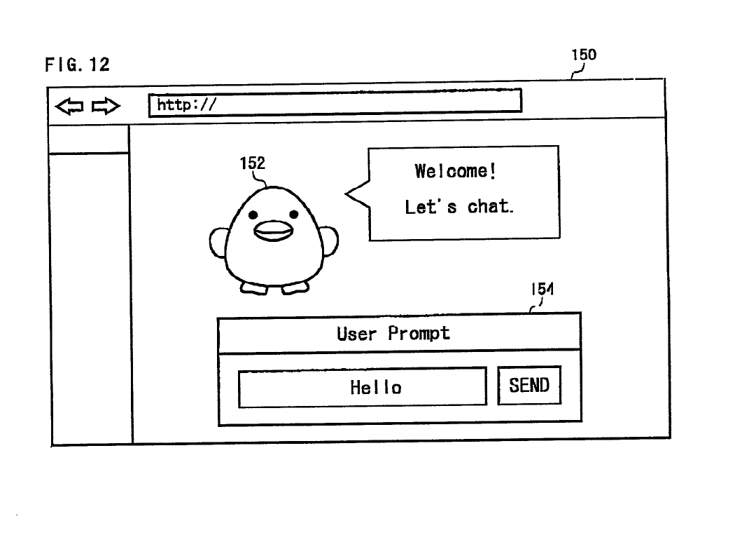

FIG. 12 shows a screen 150 displayed when a user has activated the user terminal 12. A local agent 152 appears and says, “Welcome! Let's chat.” The user inputs “Hello” in an input field 154 and presses a send button. The screen may be configured in such a manner that the input field 154 appears when the user clicks the local agent 152. In this case, as long as the user does not click, the local agent 152 may continue chatting or encourage the user to talk by asking a question. In any case the inputted statement “Hello” is sent as a process starting utterance to the originating server 20, and the chat server 24 is identified as a specialized server on the basis of the content of the statement, and the user terminal 12 is given access to a corresponding page.

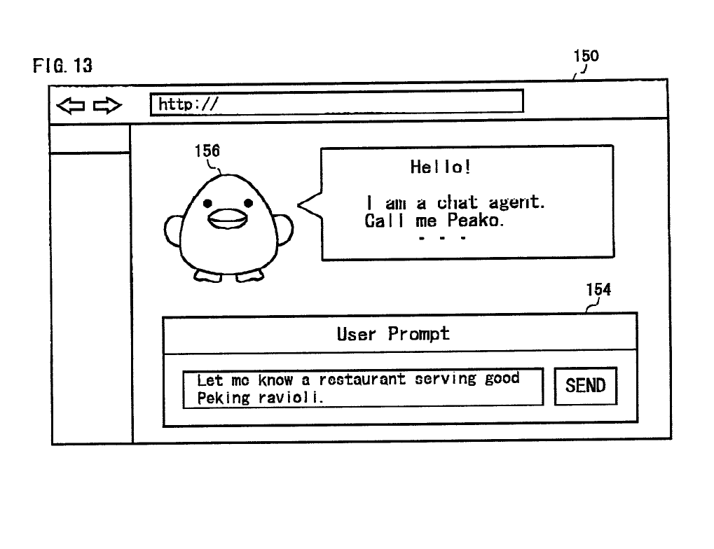

FIG. 13 shows a screen 150 displayed when the user makes an utterance. Here a chat agent 156 appears, but the same image as the local agent 152 is used in this embodiment and thus the conversation continues with no apparent seams. The chat agent 156 says, “Hello. I am a chat agent. Call me Peako.” When the user inputs “Let me know a restaurant serving good Peking ravioli.” and sends it, the utterance is obtained at the originating server 20 and a page of the gourmet server 26 is anew identified. The URL of the identified page is sent to the user terminal 12 and the user terminal 12 is given access to the page.

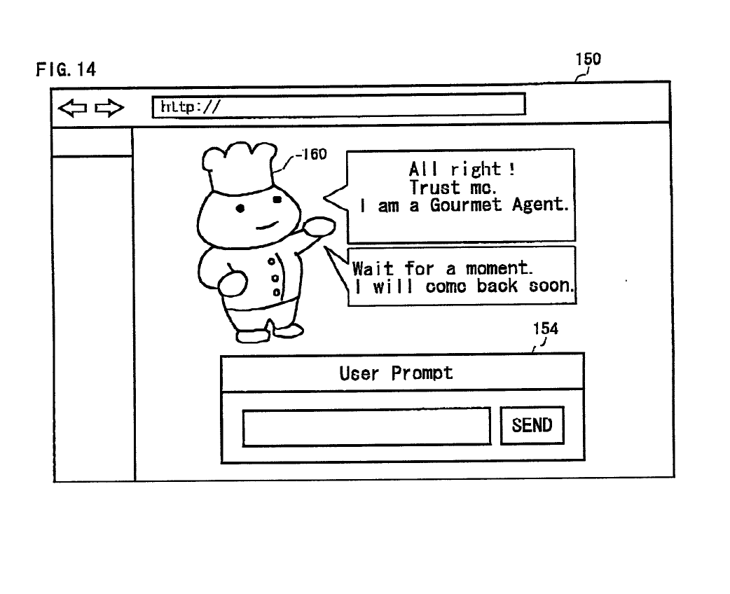

FIG. 14 shows a screen 150 displayed when the user asks for information. A new gourmet agent 160 appears and says, “All right! Trust me. I am a Gourmet Agent” and the information search unit 78 searches Web pages using “Peking ravioli” or “dumpling” as a key word. In order to prevent the user from getting bored during the search, the agent says, “Wait for a moment. I will come back soon” to tell that searching is being executed. When the search is completed, the browser is given access to a page to display a search result.

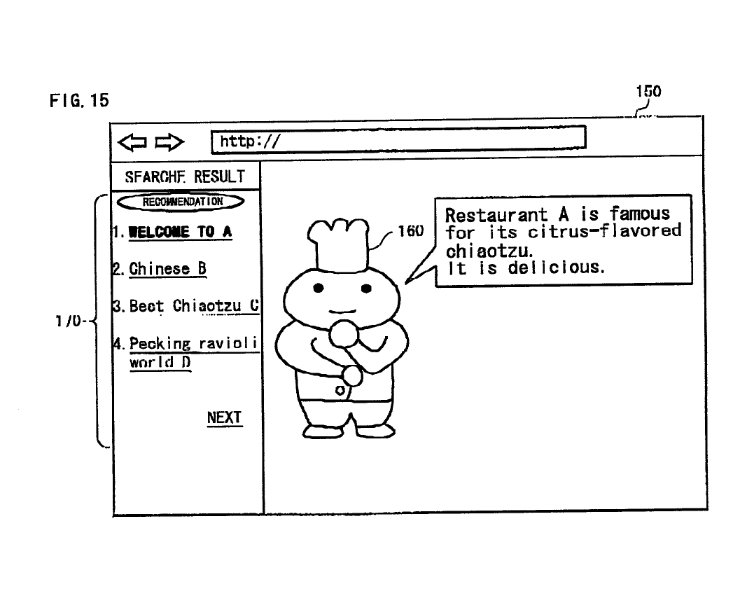

FIG. 15 shows a screen 150 displaying the search result. The titles 170 of the Web pages obtained by the information search unit 78 are displayed by the information providing unit 71. Each of the titles 170 has a link to a corresponding page. In this example, because the user has registered a Chinese restaurant A as a sponsor of the gourmet agent, the Web link of the restaurant A is displayed at the top of the recommendation list through the process in the display order setting unit 82. In addition, its font type is changed to a bold type through the process in the display attribute setting unit 84. Furthermore, the advertisement display unit 88 presents a sponsor's advertisement through the utterance of the gourmet agent 160 saying “Restaurant A is famous for its citrus-flavored chiaotzu”.

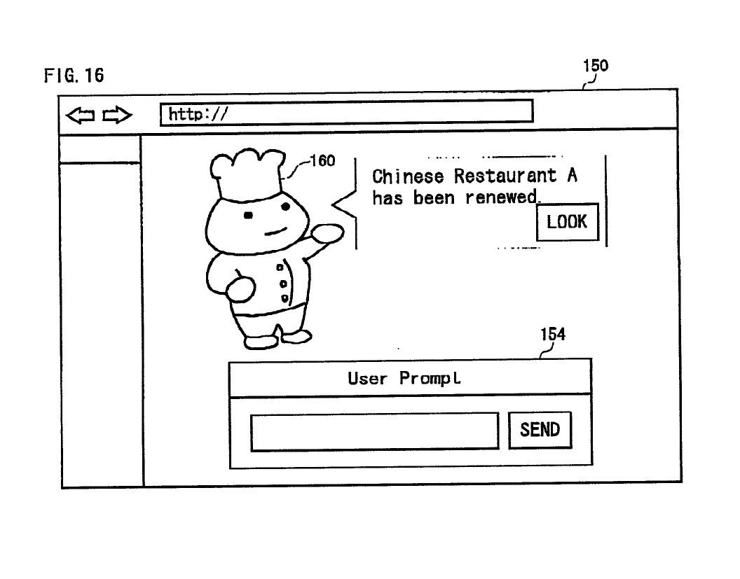

FIG. 16 illustrates a screen displayed when the gourmet agent 160 notifies the user of the updating status of the sponsor's site. In this example, the gourmet agent 160 notifies the user, who has registered the Chinese restaurant A as the sponsor, that the Chinese restaurant A's Web site has been renewed. The updating status may be checked when the user makes a related utterance, and the status may be notified only if the site has been updated. The updating status may be monitored periodically. When the system finds the site has been updated by monitoring, the user may be notified at this point or after the user makes a related utterance. The last date and time when the user visited at the sponsor site may be recorded and the user may be notified when the site is updated after the last date and time. The last date and time may be stored in a database of the originating server 20 or may be recorded on the user terminal 12 as a cookie.

Although the present invention has been described by way of exemplary embodiments, it should be understood that those skilled in the art might make numerous changes and substitutions without departing from the spirit and the scope of the present invention that is defined by the appended claims. Some such alterations are stated as follows.

Although the utterance identification block is shared at the originating server 20 in this embodiment, each specialized server may include both the utterance identification block and the response block. In such a configuration, both the user utterance collection and the agent action collection can be managed independently for each specialized field, and the management and maintenance of the agent will become easier. In any configurations, a central server may be provided to process all the utterances.

Although the user utterance is performed on a text basis in the embodiment, it may be performed using speech recognition. The agent may also make utterances in voice.

Although the unidentified utterance is considered as an utterance that is not identifiable in the user utterance collection 38, if the utterance is identifiable in the user utterance collection 38 but the response of the expert agent is not complete or fails, the utterance may be called an unidentified utterance. For instance, when the specific process execution unit 76 searches for a user utterance “Recommend a recipe” and the search results are too many to satisfy the user, the utterance may be reported to the system administrator as an unidentified utterance so that the response of the expert agent can be improved.

In the embodiment, the expert agent utterance is appropriately selected according to the record of the user's access to the specialized server. Moreover, an appropriate utterance of the agent may be selected based on the user attributes. For instance, if the user is female, a relatively gentle expression may be chosen, or if the user is an elder, a polite expression may be chosen.

Although the local agent 152 and the chat agent 156 have the same image in the embodiment, it is not necessary. The local agent 152 may be implemented on the originating server 20 instead of the user terminal 12 as a process-initiating agent, for instance.

Although the access information file 46 and the sponsor information file 50 are stored in the originating server 20 in the embodiment, these files may be stored in the user terminal 12 as temporary data, for instance, cookies.

Although the system is so configured that the user can set his/her favorite sponsors individually, the system may provide the sponsor information equally for all users who visited the specialized server.

Although such functions as the utterance identification block and the response block are implemented in the server side, part of these functions or all of these functions may be implemented or installed in the user terminal 12. For instance the identification block may be downloaded beforehand to the user terminal 12 and the utterance analysis may be performed at the user terminal, and the user terminal may access to the server having the response block. Some of functions of the specialized agent, which are particularly in frequent use, may be downloaded to the user terminal 12. Since part of or all the utterance analysis and the response process of the agent can be performed on the user terminal 12, a quick response can be realized. Thus any configuration can be made in respect to how to divide the functions between the server and the client.

What is claimed is:

1. A user support apparatus comprising:
an utterance identification block which has an electronic collection of anticipated user utterances, and identifies a content of an inputted user utterance;
a response block which has an electronic collection of action patterns for an agent for responding to the user utterances, and enables the agent to respond to the inputted user utterances;
a search unit which searches information requested by the user among information offered by a plurality of information providers; and
a process unit which executes a process for prioritizing the information providers,
wherein the utterance identification block further includes an additional collection of anticipated utterances that trigger the prioritizing process, and the process unit initiates the prioritizing process when the inputted user utterance is included in the additional utterance collection.

2. The apparatus of claim 1, wherein the additional utterance collection is incorporated into the user utterance collection.

3. The apparatus of claim 1, wherein the process unit arranges information related to a specific information provider at the top of a list of search results obtained by the search unit.

4. The apparatus of claim 1, wherein the process unit emphasizes information related to a specific information provider when a search result obtained by the information search unit is presented to the user.

5. The apparatus of claim 1, wherein the process unit displays a search result obtained by the information search unit with an advertisement of a specific information provider attached.

6. The apparatus of claim 1, wherein the process unit monitors an updating status of information related to a specific information provider and notifies the user of the updating status when the information has been updated.

7. The apparatus of claim 1, further comprising a charging unit which charges an information provider granted a high priority by the process unit.

8. The apparatus of claim 1, further comprising a setting unit which enables the user to register a specific information provider to be granted a high priority, and wherein the process unit executes the prioritizing process for the registered specific information provider.

9. The apparatus of claim 1, further comprising an awarding unit which awards the user a merit when the user registers a specific information provider to be granted a high priority.

10. The apparatus of claim 1, further comprising a library providing unit which offers the user utterance library to a third party off line or on line.

11. The apparatus of claim 1, further comprising a recording unit which obtains a record of the user's access to the system, wherein the response block chooses one from a plurality of choices of the action patterns of the agent to respond to the user utterance depending on the user's access record.

12. A user support system comprising a plurality of said user support apparatuses of claim 1 connected to a network as independent network nodes, each of the apparatuses corresponding to one specialized field, wherein the user utterance collection, the agent action collection, and the additional utterance collection of each of the apparatuses are generated according to each specialized field.

13. The system of claim 12, wherein the plural user support apparatuses include the respective response blocks therein and share the utterance identification block at any one of the network nodes.

14. The system of clam 12, wherein the utterance identification block of the user support apparatus further includes an index storage that stores an index of contents of the user utterance collection, and the information search unit initially searches the inputted user utterance in the index storage.

15. The system of claim 12, wherein the user support apparatus further comprises a library providing unit which offers the user utterance library to a third party off line or on line.

16. The system of claim 12, wherein the user support apparatus further comprises a recording unit which obtains a record of the user's access to the system, wherein the response block chooses one from a plurality of choices of the action patterns of the agent to respond to the user utterance depending on the user's access record.

17. The system of claim 12, wherein the process unit of the user support apparatus arranges information related to a specific information provider at the top of a list of search results obtained by the search unit.

18. The system of claim 12, wherein the process unit of the user support apparatus emphasizes information related to a specific information provider when a search result obtained by the information search unit is presented to the user.

19. The apparatus of claim 12, wherein the process unit of the user support apparatus displays a search result obtained by the information search unit with an advertisement of a specific information provider attached.
